(19) United States
(12) Patent Application Publication
(10) Pub. No.: US 2006/0194049 A1
(43) Pub. Date: Aug. 31, 2006

(54) Lead for writing, drawing and painting utensils

(75) Inventors: Andreas Thies, Effeltrich (DE); Christa Lehrer, Neumarkt i.d. Opf (DE); Jurgen Reiner, Neumarkt i.d. Opf (DE); Christine Delapierre, Herzogenaurach (DE); Robert Nein, Nurnberg (DE); Franz Ochsenkuhn, Neumarkt i.d. Opf (DE); Max Heindl, Neumarkt i.d. Opf (DE)

Correspondence Address: Friedrich Kueffner;Suite 910, 317 Madison Avenue, New York, NY, 10017, US

(73) Assignee: J.S. Staedtler GmbH & Co.

(21) Appl. No.: 11/342,275

(22) Filed: Jan. 26, 2006

(30) Foreign Application Priority Data
Jan. 26, 2005 (DE) 10 2005 004 175.2

(51) Int. Cl. C09D 13/00; D02G 3/00

(52) U.S. Cl. 428/375; 106/31.11

(57) ABSTRACT

A lead for writing, drawing and painting utensils has a colorant lead core and at least one lead coat extending in the direction of the longitudinal axis. The at least one lead coat envelopes the lead core as seen in cross section of the lead and the lead coat and lead core are immovably mounted relative to each other. The at least one lead coat has a higher bending strength than the lead core.

### BACKGROUND OF THE INVENTION

1. Field of the Invention

The present invention relates to a lead for writing, drawing and painting utensils.

2. Description of the Related Art

Leads for writing, drawing and/or painting are known in principle in the art.

Known writing or painting leads are generally made as full-core leads or chalks and fixedly or movably fastened in a sheath.

One-piece, homogenously formed leads are state of the art, which present a compromise of desired writing characteristics which among others are adjustable via the lead hardness, and the lead strength required for the application.

If the lead strength falls short of the minimum, usually the only possibility of increasing the load capacity of the lead is to enlarge the lead diameter.

It is disadvantageous in this regard that an increase in the lead diameter and consequently in the lead material used, leads to a significant rise in cost of the lead. Further, it is disadvantageous that an enlarged lead diameter has negative effects on the compression velocity, drying time and energy demand.

Multicolored leads are known from DE-GM 12 01 339 and from patent application DE-H 142 675 wherein different colored leads are mounted one within the other. Multicolored strokes can be made with such leads or pencils. It is disadvantageous with regard to these described leads and, therefore, for pencils made therewith, that in spite of the interleaved arrangement of multicolored shells one within the other no increase in the bending strength can be attained relative to a single-color lead, which results in the fact that these pencils generally tend to break off quickly.

Further, fired pencil leads as well as the method for their production are known from DE 43 32 582 A1. For leads of this type a lead mass is compressed such that one or several layers are arranged between the central area and the outer peripheral area in radial direction at a distance from the outer peripheral area, in which filler material is aligned in a concentric, duct-shaped form, wherein the filler material is arbitrarily or radially aligned in the other areas of the lead. It is disadvantageous that this is an elaborate production method. An example therefore is that very high shear energies arise in the extruder with this method by means of the disk-shaped additions, which dramatically reduces the compression performance. A decisive disadvantage is the fact that the strength increase which is effected in this way is not high enough to justify the incurred outlay for production. The used or deployed lead material is identical across the entire lead cross section, which leads to a high usage of high quality lead mass which itself would only be needed in the writing area or tip area.

### SUMMARY OF THE INVENTION

The primary object of the present invention to provide a fired or unfired lead for writing, drawing or painting that does not have the above-mentioned disadvantages and which in particular has a higher load bearing capacity against outer forces, without changing the applied lead composition of the coloring material, the so-called lead core, in the process. The object is to reduce the susceptibility of the lead to breaking due to high writing forces as well as due to sharpening forces.

This object is met by means providing a lead coat with a higher bending strength than the lead core.

Leads for writing, drawing or painting include, on the one hand, leads which are fixedly inserted in wood or another sharpenable material and, on the other hand, leads which are movably retained in a bending resistant jacket. Examples include wood-cased graphite and colored pencils, thin lead for mechanical leadholders, so-called mechanical pencils and leads for clutch pencils. Leads of this type usually have outer diameters in the area of approximately 0.3 mm to 6 mm.

Graphite or color leads may also either be fired or unfired leads.

In addition, the invention may also be applied to crayons made of wax.

The stated object is met in that the leads according to the invention are constructed such that they have at least one lead coat which essentially extends concentrically around the lead core or the centerline of the lead.

The lead core can exhibit a composition according to the state of the art.

The lead coat which envelopes the lead core acts as a protective shell. This protective shell exhibits a heightened strength in order to increase the stability of the lead against breaking. There is the possibility of designing the protective shell which envelopes the lead core in color, wherein the used colors may indicate information about for example, the manufacturer, degree of hardness, lead type or stroke thickness. By means of a color differentiation of the lead coat from the lead core, it is possible to create a trademark-specific and optically distinguishable characteristic which signals to the consumer or user the presence of a higher-quality lead already optically on the sharpened lead by means of a colored ring made on the tapered surface.

As an example, it should be mentioned that the bending strength of leads increases significantly by 20 to 60% due to the coating of a lead core, which is made of the lead material known in the art, compared with a lead according to the state of the art without coating, with the same total cross section, as well as for graphite and color pencils.

In the case of such an increase in the bending strength of coated leads, the total cross section of the coated leads could also be reduced, without forfeiting strength relative to non-coated leads according to the state of the art. A cost savings is the direct result.

The production costs can be notedly lowered by using inexpensive coat materials.

In addition, it has become known that deviations in the quality and process tolerance of the core material can be leveled or equalized by means of special coatings.

The composition of the material for the coat zone can generally be made of more cost-effective raw materials than the core or lead which is exactly adjusted to the desired writing properties. For example, clay could be used in place of graphite. The lead coat only serves as a protective shell for the normal use of a wood-cased writing, drawing or painting utensil and is just sharpened away unused by the user when the lead core is dull.

It is advantageous in the case of such a lead that in spite of the strength increase by means of the coat material encompassing the lead core, no significant impairment of the writing quality occurs, since the lead core may have the same composition as a heretofore manufactured full lead according to the state of the art. On the contrary, the lead core for coated leads can be clearly optimized pertaining to the writing properties, since a significant strength input is effected by means of the coat.

The lead cross section can either be circular, oval, triangular, hexagonal, rectangular or designed with almost any shape.

A circular shape however is preferred.

One or several lead coats can be arranged concentrically around the lead core.

A concentric arrangement ensures that the lead has the same strength and writing properties independently of the writing position and thus the pressure load in all directions.

If several lead coats or coat zones are present, the individual coats may have different colors and/or compositions.

In order to produce a coated lead with high quality, the following boundary conditions must be met. In this case, the lead coat of a lead designed according to the invention
Should exhibit an identical or similar plasticity as the lead core,
the flow performance of the coat material should approximately correspond to that of the core material,
the coat material should exhibit a higher bending strength than the core material,
the shrinkage performance of the coat should be adapted to the core material in order to avoid the formation of cracks during the drying and firing process,
the separating line or interface between the coat zone and the writing core should preferably be radially and/or axially irregular, in order to guarantee structural interlocking,
the coat volume should be smaller or equal to the core volume.

In this way, the coated lead with a circular cross section, which is provided with at least one lead coat extending the entire length concentrically relative to its longitudinal axis, exhibits a higher bending strength compared with a full lead whose cross sectional area is selected to be exactly equally large relative to the cross sectional area of the coated lead.

At the same time, the composition and/or the surface of the lead coat can be designed such that a better bonding is attained while gluing the lead into the wood holder.

It has been shown that it is advantageous if the cross section of the lead coat as well as the cross section of the lead core has a round shape, otherwise notch forces arise at the edges which cannot be neglected and which result in a reduction of the bending strength.

An additional advantage of the invention is that the lead core can be improved or adjusted with regard to special properties such as abrasion performance or gliding properties, since the stability is predominantly built up by means of the coat material.

The various features of novelty which characterize the invention are pointed out with particularity in the claims annexed to and forming a part of the disclosure. For a better understanding of the invention, its operating advantages, specific objects attained by its use, reference should be had to the descriptive matter in which there are described preferred embodiments of the invention.

### BRIEF DESCRIPTION OF THE DRAWING

FIG. 1. is a sectional view of a coated lead according to the invention with a lead coat;

FIG. 2 is a cross sectional view of the lead according to FIG. 1;

FIG. 3 is a cross sectional view of a lead according to the invention which is glued in wood;

FIG. 4 is a cross sectional view of a lead according to the invention with two lead coats.

### DETAILED DESCRIPTION OF THE INVENTION

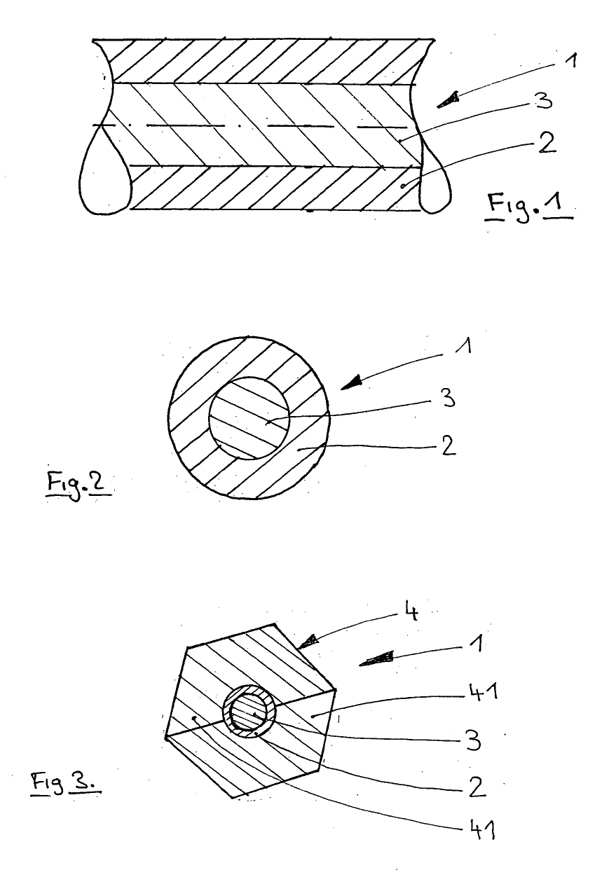

FIG. 1 shows a coated lead 1 with a lead coat 2 in longitudinal section, wherein in this embodiment the lead coat 2 is extends concentrically around the longitudinal axis of the lead core.

FIG. 2 shows the lead or coated lead 1 according to FIG. 1 in cross section.

From this view, the concentric build of the lead 1 is clearly visible. In this embodiment the lead core 3 is enveloped by a lead coat 2.

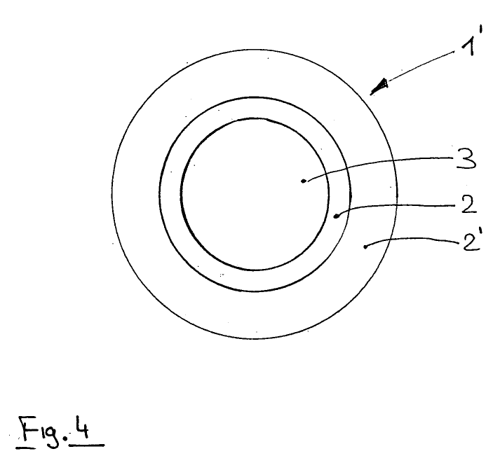

FIG. 3 shows an encased lead 1 comprising a lead core 3 and a lead coat 2 with a sheath 4 made out of two wood slats 41, wherein the coated lead 1 is glued into the notches of the wood slats 41, as it is known from a standard graphite or colored pencil. The wood-cased pencil has a hexagonal outer contour in this embodiment.

FIG. 4 shows a further embodiment of a coated lead 1′ according to the invention. The lead core 3 is surrounded by two lead coats 2 and 2′ in this embodiment. The shown configuration in this case is also a concentric system.

Embodiment variations of the leads are not shown in the drawings which exhibit three or more lead coats. The coats may be for example chemically or ceramically bonded coats. The order in which the lead coats are arranged is arbitrary. It is important, however, that at least one lead coat exhibits a higher strength than the lead core.

It can be stated that an increase in the stability of the lead against breaking is effected by means of the lead design according to the invention. In addition, the lead is already less prone to breaking in the manufacturing process, which results in a lower reject rate.

For the user of the writing utensil with a lead according to the invention, it is advantageous that the lead point is capable of bearing a higher writing force compared with a full lead with a uniformly configured cross sectional area, and that as a result, impression forces common for children learning to write can be easily endured.

In order to present the invention in more detail, examples of recipe compositions for the lead core and lead coat are provided in the following.

Recipe example for a lead coated lead

| | |
|---|---|
| Lead core: Hardness HB | |
| Graphite | 65 weight % |
| Clay | 35 weight % |
| Lead coat: Hardness H | |
| Graphite | 60 weight % |
| Clay | 40 weight % |

In this recipe example a soft graphite core with a hardness HB is enveloped with a harder coat (hardness H). The core as well as the coat is made of a colorant material.

The following table shows how the strength of the coated lead changes relative to a full lead. The area ratio of coat area to core area equals 1.

| | | Full | Coated | Strength |
|---|---|---|---|---|
| Strength | Unit | Lead | Lead | Increase |
| Bending strength | MPa | 84 | 113 | +36% |
| of the lead | | | | |
| Point-breaking | N | 30 | 50 | +66% |
| strength of the | | | | |
| pencil | | | | |

An increase in the strength results from the rise in the bending tension. Generally, an increase in the point-breaking strength results from a rise in the bending strength of the lead and an improved gluing of the coat material due to its optimized chemism.

Recipe example of a colored coated lead

| | |
|---|---|
| Lead core: yellow | |
| Organic pigment | 7 weight % |
| Inorganic pigment | 15 weight % |
| Lubricant | 8 weight % |
| Binding agent | 5 weight % |
| Filler material | residual |
| Lead coat: white | |
| Inorganic pigment | 20 weight % |
| Lubricant | 15 weight % |
| Binding agent | 9 weight % |
| Filler material | residual |

The strength changes in bending and point-breaking are documented in the following table.

| | Ratio | | | |
|---|---|---|---|---|
| | Core/Coat | Full | Coated | Strength |
| Strength | area | Lead | Lead | Increase |
| Bending | 1.44 | 46 | 52 | +13% |
| strength of the | | | | |
| lead in MPA | | | | |
| Point breaking | 1.44 | 17 | 27 | +59% |
| strength of the | | | | |
| pencil in N | | | | |

Also in this example it is apparent that an additional increase in the stability results from the improved gluing of the lead in the wood by means of an optimized or adapted coat composition.

In this embodiment of a lead according to the invention, in which a yellow lead core is enveloped by a white lead coat, the coat can be seen as a white ring in a sharpened state. If such a lead is cased in wood, a transition from the wood via a white ring to the yellow lead core can be seen in the area of the tip. It can be advantageous if the color of the ring, i.e. the coat material, contains information which may indicate for example the manufacturer, degree of hardness, lead diameter etc. to the user.

In each of the described cases it has been shown that a deterioration of stroke quality does not occur.

Such a coated lead can be made for example by means of coextrusion.

The invention relates to a lead for writing, drawing and painting utensils, which exhibit a colorant lead core and at least one lead coat in the direction of the longitudinal axis, wherein the at least one lead coat envelops the lead core as seen in the cross section of the lead and wherein the lead coat and the lead core are immovably suspended relative to each other and the at least one lead coat exhibits a higher bending strength than the lead core. The lead coat which as seen in cross section of the lead core forms a lead jacket, exhibits a higher bending strength than the lead core. The lead coat or the lead coats are arranged concentrically relative to or around the lead core, wherein at least one lead coat has a different color than the lead core. For example, the at least one lead coat may be in white color.

The at least one lead coat may be a colorant or non-colorant.

The material composition of the lead core and the material composition of the lead coat can differ.

In addition, the lead core and the at least one lead coat may be made of materials with various grain size distribution and/or grain fineness.

As seen in cross section of the lead, the lead coat can exhibit a smaller or equal cross sectional area than the lead core.

As seen in cross section of the lead, the outer diameter of the lead core can be interlocked and/or otherwise mechanically anchored with the inner diameter of the lead coat adjacent the lead core.

There is a separating line or an interface between the lead coat and the lead core, wherein the separating line is preferably radially and/or axially irregular.

The lead core may exhibit a ceramic bonding or an organic bonding. Likewise, the lead coat may exhibit a ceramic bonding or an organic bonding. The at least one lead coat may be under compressive stress.

While specific embodiments of the invention have been described in detail to illustrate the inventive principles, it will be understood that the invention may be embodied otherwise without departing from such principles.

We claim:

1. A lead for writing, drawing and painting utensils, the lead comprising a colorant lead core and at least one lead coat extending in a direction of a longitudinal axis thereof, wherein the at least one lead coat envelops the lead core as seen in cross section of the lead and wherein the lead coat and lead core are immovably mounted relative to each other, and wherein the at least one lead coat has a higher bending strength than the lead core.

2. The lead according to claim 1, wherein the lead coat which form a lead jacket, as seen in cross section of the lead, has a higher bending strength than the lead core.

3. The lead according to claim 1, wherein the at least one lead coat is arranged concentrically relative to the lead core.

4. The lead according to claim 1, wherein the at least one lead coat has a different color than the lead core.

5. The lead according to claim 1, wherein the at least one lead coat is white.

6. The lead according to claim 1, wherein the at least one lead coat is colorant or non-colorant.

7. The lead according to claim 1, wherein a material composition of the lead core and a material composition of the lead coat are different.

8. The lead according to claim 1, wherein the lead core and the at least one lead coat are of materials with different grain size distribution and/or grain fineness.

9. The lead according to claim 1, wherein as seen in cross section of the lead, the lead coat has a smaller or equally big cross sectional area as the lead core.

10. The lead according to claim 1, wherein an outer diameter of the lead core meshes with and/or is otherwise mechanically anchored with an inner diameter of the lead coat adjacent the lead core.

11. The lead according to claim 1, wherein there is a separating line or an interface formed between the lead coat and the lead core, and wherein the separating line is radially and/or axially irregular.

12. The lead according to claim 1, wherein the lead core comprises a ceramic bonding or an organic bonding.

13. The lead according to claim 1, wherein the at least one lead coat comprises a ceramic bonding or an organic bonding.

14. The lead according to claim 1, wherein the at least one lead coat is subjected to compressive stresses.
